(19) United States
(12) Patent Application Publication
(10) Pub. No.: US 2026/0259906 A1
(43) Pub. Date: Sep. 3, 2026

(54) CONTEXTUALIZATION OF VERSION CONTROL REQUESTS UTILIZING NATURAL LANGUAGE PROCESSING FOR AI BASED INFUSION

(71) Applicant: International Business Machines Corporation, Armonk, NY (US)

(72) Inventors: Jeremy R. Fox, Georgetown, TX (US); Mu Qiao, Belmont, CA (US); Martin G. Keen, Cary, NC (US); Zachary Augustus Silverstein, Georgetown, TX (US)

(21) Appl. No.: 19/067,122

(22) Filed: Feb. 28, 2025

(51) Int. Cl. G06F 16/3332; G06F 40/295

(52) U.S. Cl. CPC G06F 16/3334; G06F 40/295

(57) ABSTRACT

A system includes a processor that executes computer executable components stored in a memory. The computer executable components can include a tracking component that tracks content changes. The computer executable components can further include a natural language processing component that interprets a natural language query. The computer executable components can further include an artificial intelligence component that contextualizes, based at least in part on the tracked content changes, the query and infers sufficiency of a potential result of the contextualized query.

### TECHNICAL FIELD

The subject disclosure relates to contextualization of version control requests, e.g., utilizing natural language processing for artificial intelligence-based infusion.

### BACKGROUND

The need for efficient access to content has become increasingly necessary as organizations become larger, more complex, and operate in a more collaborative environment. As a result, version control systems have been implemented to enable multiple users to collaborate on a same project simultaneously, while also ensuring that everyone has access to latest content. However, these systems are not always effective in helping users find an exact version of content they seek.

Often, users have difficulty remembering exact keywords or phrases to search for content, which can lead to frustration and inefficiencies when trying to find a correct version of a document. In addition, current version control systems are not able to accurately interpret and understand context of a user's query in order to provide most relevant search results.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate contextualization of version control requests.

According to an embodiment, a system can comprise a processor that executes computer executable components stored in memory. The computer executable components can comprise tracking component that tracks content changes. The computer executable components can further comprise natural language processing component that interprets a natural language query. The computer executable components can further comprise an artificial intelligence component that contextualizes, based at least in part on the tracked content changes, the query and infers sufficiency of a potential result of the contextualized query.

According to another embodiment, a computer-implemented method can comprise tracking, by a system operatively coupled to a processor, content changes. The computer-implemented method comprises interpreting, by a system, a natural language query. The computer-implemented method further comprises contextualizing, by a system, based at least in part on the tracked content changes, the query. The computer implemented method can further comprise inferring, by the system, a potential result of the contextualized query.

According to another embodiment, a computer program product comprising a computer readable storage medium having program instructions embodied therewith, the program instructions executable by a processor to cause the processor to track, by the processor, content changes. The program instructions can also cause the processor to receive, by the processor, a natural language query. The program instructions can also cause the processor to contextualize, by the processor, based at least in part on the tracked content changes, the query. The program instructions can further cause the processor to infer, by the processor, a potential result of the contextualize query.

### BRIEF DESCRIPTION OF THE DRAWINGS

FIGS. 1 and 2 illustrate example systems that can facilitate contextualization of version control requests in accordance with some embodiments described herein.

FIGS. 3-5 illustrate flow diagrams of example computer implemented methods that can facilitate contextualization of version control requests in accordance with some embodiments described herein.

FIG. 6 illustrates an example entity relationship diagram in accordance with some embodiments described herein.

FIG. 7 illustrates an example code for training a natural language processing model in accordance with some of the embodiments described herein.

FIG. 8 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

Version control systems allow for multiple collaborators to work on projects simultaneously. These systems can track changes made to documents, code, or other digital content, thereby enabling users to maintain continuity across different stages of work. The ability to structurally manage changes and prevent conflicts has become an indispensable tool for organizations, particularly those in fast paced and complex environments. However, despite the above-described benefits, current version control systems struggle with retrieving specific versions of content efficiently. As volume of content increases, so too does complexity of managing it, which can make finding a specific version of content cumbersome. A major problem with existing technology is that users cannot efficiently retrieve specific versions of content based on natural language queries. Current systems predominantly rely on keyword-based searches, which require users to remember specific words or phrases associated with the version they are trying to locate. Furthermore, a greater number of collaborators usually corresponds to increased number of content versions, making issues of retrieving a specific content version increasingly difficult. As a result, unnecessary time can be wasted trying to retrieve a specific content version. In industries where speed and precision are crucial, this loss in productivity can prove consequential.

In large, collaborative environments where multiple people contribute, it becomes progressively difficult to recall these details accurately. As a result, users can spend a significant amount of time combing through different versions, which can hamper productivity. This issue is particularly pronounced in industries where precision and speed are crucial, such as software development.

Inefficiencies in searching for correct versions of desired content can be addressed with improved contextualization. Current version systems experience difficulty with accurately interpreting context of search queries. Even when users or systems have a general idea of content that they are searching for, version control systems often fail to infer context and match it with relevant content. Using contextual clues to interpret a user's request can be vital for accurate retrieval of content. Identifying the five W's and H (“who,” “what,” “where,” when,” and “how”) streamlines the process of contextualizing a query. Additionally, using contextual awareness, such as recognizing user intent, previous contribution history, and/or relevance to certain projects, narrows down potential results more effectively.

To address these challenges, integrating natural language procession (NLP) and artificial intelligence (AI) contextualization into version control systems can greatly improve the way in which versions of content are searched for and retrieved. By utilizing NLP capabilities, desired content can be requested in a natural language formatted query, processed, and passed to an AI module.

For example, a user may formulate a query such as “I'm looking for the latest version of the design document I was working on last week with Sarah for the XYZ project” to yield the correct version of the document without need to recall specific keywords. In this example, the NLP can preprocess the natural language query and run it against the AI module to identify at least one of the five W's and H. The AI module can utilize contextual awareness to help further understand a request of the user. Once context of a query is understood, the system can provide relevant result(s) or ask the user to answer additional outstanding questions to narrow down the search.

The innovations disclosed herein can improve ability of version control systems to efficiently retrieve desired content, especially for large and complex projects.

In relation to contextualization of version control requests, embodiments disclosed herein produce a solution to one or more of these problems. These embodiments can solve such problems by tracking content changes; by interpreting a natural language query; by contextualizing, based at least in part on the tracked content changes, the query; and by inferring a potential result of the contextualized query.

According to an embodiment, a system can include a processor that executes computer executable components stored in a memory. The computer executable components can include a tracking component that tracks content changes. The computer executable components can further include a natural language processing component that interprets a natural language query. The computer executable components can further include an artificial intelligence component that contextualizes, based at least in part on the tracked content changes, the query and infers sufficiency of a potential result of the contextualized query.

In some embodiments, the system can further comprise a search component that executes the contextualized query.

In some embodiments, the artificial intelligence component can determine sufficiency of the query as a function of a confidence score of utility to a user of the query. The artificial intelligence component can further use situational analysis to determine sufficiency of the query. According to an embodiment, upon determining that the query will not result in utility, the artificial intelligence component can request more information. In other embodiments, the artificial intelligence component can provide customized recommendations to modify the natural language query. The customized recommendations can be based at least in part upon the tracked content changes. In various embodiments, the artificial intelligence component can use named entity recognition to contextualize the query. The artificial intelligence component can further analyze metadata of the potential query result. The artificial intelligence component can use keyword extraction to contextualize the query.

In some embodiments, the natural language processing component can utilize word embedding to interpret the query.

Advantages of this system may include streamlined content selection and retrieval, enhanced search efficiency, and increased productivity.

According to some embodiments, the above-described computer system may be implemented as a computer-implemented method or as a computer program product.

Some embodiments of the present disclosure are now described with reference to the drawings. In the drawings, like referenced numerals are used to refer to like elements throughout. In the following description, for purposes of explanation, numerous specific details are set forth in order to provide a more thorough understanding of the embodiments. In various cases, some embodiments may be practiced without these specific details, yet a person having ordinary skill in the art will recognize that such embodiments are within metes and bounds of this disclosure.

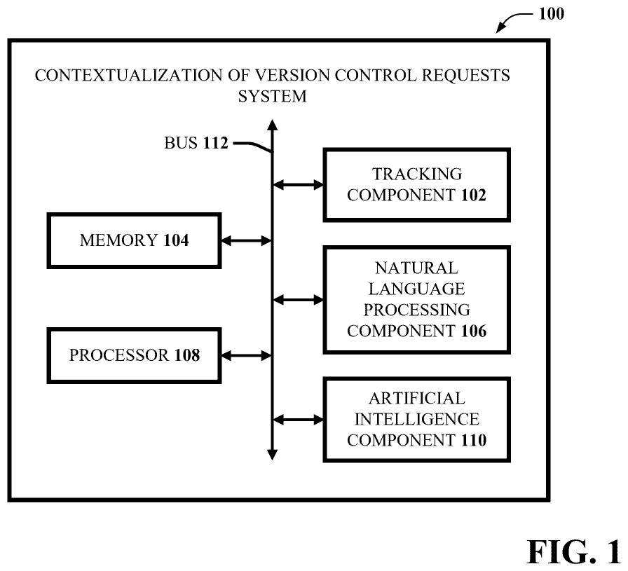

FIG. 1 illustrates an example system 100 for facilitating contextualization of version control requests. System 100 uses a tracking component, a natural language processing component, and an artificial intelligence component. The tracking component tracks content changes. The natural language processing component interprets a natural language query. The artificial intelligence component contextualizes, based at least in part on the tracked content changes, the query and infers sufficiency of a potential result of the contextualized query.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by one or more machines (e.g., computers, computing devices, virtual machines, etc.) can cause the machines to perform the operations described. System 100 may comprise a tracking component 102, a memory 104, a natural language processing component 106, a processor 108, an artificial intelligence component 110, and a system bus 112.

The system 100 and/or the components of the system 100 can use hardware and/or software to solve problems that are highly technical in nature. System 100 solves problems that are not abstract and that cannot be performed as a set of mental acts by a human. Further, some of the processes may be performed by specialized computers for carrying out defined tasks related to recovery plan development. The system 100 and/or components of the system 100 can be employed to solve new problems that arise through advancements in technologies. The system 100 can provide technical improvements to contextualization of version control requests by enhancing search efficiency and increasing productivity.

System 100 may include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that can be operably connected to the processor 108. The memory 104 can store computer-executable instructions that, upon execution by the processor 108, may cause the processor 108 and/or one or more other components of the system 100 (e.g., the tracking component 102, the natural language processing component 106, and/or the artificial intelligence component 110) to perform one or more actions. In some embodiments, the memory 104 can store computer-executable components (e.g., the tracking component 102, the natural language processing component 106, and/or the artificial intelligence component 110).

The system 100 and/or a component thereof as described herein can be communicatively, electrically, operatively, optically, and/or otherwise coupled to one another via a bus 112. The bus 112 can include one or more of a memory bus, memory controller, peripheral bus, external bus, local bus, and/or another type of bus that can employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writable, and/or executable components and/or instructions. When executed by the processor 108, these components and/or instructions can enable performance of one or more operations defined by the component(s) and/or instruction(s).

In various embodiments, the tracking component 102 tracks content changes. Tracking component 102 can monitor and detect changes made to content, such as additions, deletions, or updates. When changes are detected, tracking component 102 can capture relevant metadata, such as timing of modification, type of modification, and/or an identity of a user or system that initiated the change. Tracking component 102 can incorporate version control functionality, maintaining a history of content modifications and allowing users or systems to revert to previous versions.

According to some embodiments, the natural language processing component 106 interprets a natural language query. Natural language processing component 106 can utilize word embedding to interpret the query. Natural language processing component 106 can process an unstructured query with identified key information.

In various embodiments, the artificial intelligence component 110 can contextualize, based at least in part on the tracked content changes, the query and infers sufficiency of a potential result of the contextualized query. Artificial intelligence component 110 can determine sufficiency of the query as a function of a confidence score of utility to a user of the query. The artificial intelligence component 110 can further use situational analysis to determine sufficiency of the query. According to an embodiment, upon determining that the query will not result in utility, artificial intelligence component 110 can request more information. In other embodiments, the artificial intelligence component 110 can provide customized recommendations to modify the natural language query. The customized recommendations can be based at least in part upon the tracked content changes. In various embodiments, artificial intelligence component 110 can use named entity recognition to contextualize the query. The artificial intelligence component 110 can analyze metadata of the potential query result. Artificial intelligence component 110 can use keyword extraction to contextualize the query.

Artificial intelligence component 110 can contextualize a natural language query by utilizing various techniques. For example, the AI component 110 can analyze grammatical structure of a sentence (syntax) and meaning of words (semantics) to facilitate the AI component 110 determining relationships between words and phrases. AI models often use word embeddings, which are numerical representations of words in a continuous vector space. This allows the model to capture contextual meanings based on how words are used in relation to each other. Advanced models like transformers (e.g., BERT, GPT) consider the entire context of a sentence or paragraph rather than looking at words in isolation. This enables the Artificial intelligence component 110 to understand nuances, such as sarcasm or idiomatic expressions. AI component 110 can identify and categorize key entities (such as people, places, and organizations) within a query, allowing it to understand what the user is specifically referring to. When a word has multiple meanings (e.g., “bank”), AI component 110 can use context clues from the surrounding words to determine the intended meaning. The AI component 110 can incorporate user behavior and historical data to predict what the user is likely trying to achieve with their query, enhancing relevance of a response. In conversational AI, maintaining context over multiple turns of conversation helps the AI component 110 remember previous interactions and respond appropriately based on earlier exchanges. By integrating one or more of the foregoing techniques, the AI component 110 can effectively interpret and respond to natural language queries in a way that feels intuitive and relevant to a user.

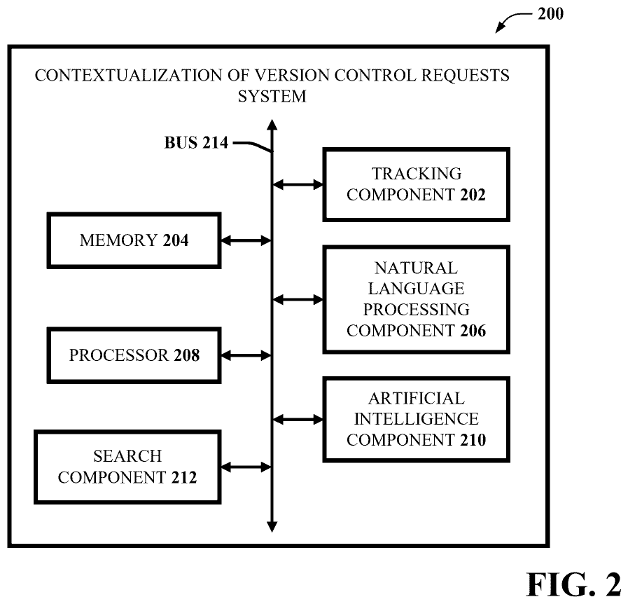

FIG. 2 illustrates an example system 200 that can facilitate contextualization of version control requests. System 200 uses tracking component 202, natural language processing component 206, artificial intelligence component 210 and search component 212. The tracking component 202 tracks content changes. The natural language processing component 206 interprets a natural language query. The artificial intelligence component 210 contextualizes, based at least in part on the tracked content changes, the query and infers sufficiency of a potential result of the contextualized query. Description of like components has been omitted for the sake of brevity.

In various embodiments, search component 212 executes the contextualized query. Once a potential result of the query is found, search component 212 can retrieve the result and deliver it to the user or system for further action.

The systems and/or devices are described herein with respect to interaction between one or more components. Such systems and/or components can include the components and/or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity but known by those of skill in the art.

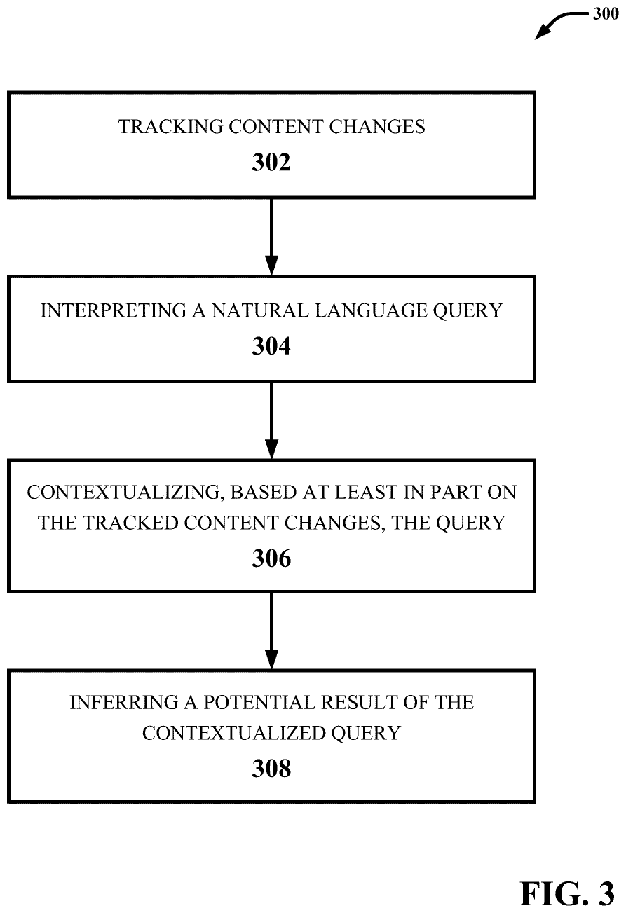

Next, FIG. 3 illustrates a flow diagram of a method 300 that can facilitate contextualization of version control requests in accordance with some embodiments described herein, such as the system 200 of FIG. 2 and the system 100 of FIG. 1. While the method 300 is described relative to the system 200 of FIG. 2, the method 300 can be applicable also to other systems described herein. Repetitive description of like elements and/or processes employed in respective embodiments is omitted for sake of brevity.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

At 302, the method 300 includes tracking content changes. The method 300 can use a system operatively coupled to the processor (e.g., tracking component 202) to track the content changes.

At 304, method 300 includes interpreting a natural language query.

At 306, method 300 includes contextualizing, based at least in part on the tracked content changes, the query.

At 308, method 300 includes inferring a potential result of the contextualized query.

In some embodiments, method 300 is performed by a system, such as system 100 of FIG. 1 or system 200 of FIG. 2. The tracking content changes 302 can be performed by a tracking component (e.g., tracking component 202 of FIG. 2). The interpreting a natural language query 304 can be performed by a natural language processing component (e.g., natural language processing component 206). Contextualizing, based at least in part on the tracked content changes, the query 306 can be performed by an artificial intelligence component (e.g., artificial intelligence component 210). The inferring a potential result of the contextualized query 308 can be performed by an artificial intelligence component (e.g., artificial intelligence component 210).

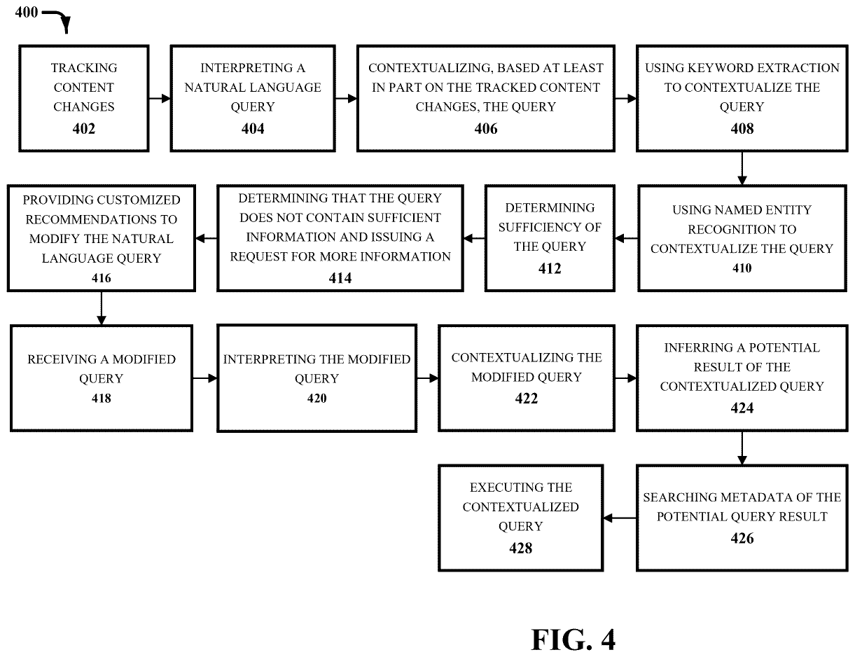

Next, FIG. 4 illustrates a flow diagram of a method 400 that can facilitate contextualization of version control requests in accordance with some embodiments described herein. While the method 400 is described relative to the system 200 of FIG. 2, the method 400 can be applicable also to other systems described herein, such as the system 100 of FIG. 1.

At 402, the method 400 includes tracking content changes. The method 400 can use a system operatively coupled to the processor (e.g., tracking component 202) to track the content changes.

At 404, method 400 includes interpreting a natural language query.

At 406, method 400 includes contextualizing, based at least in part on the tracked content changes, the query.

At 408, method 400 includes using keyword extraction to contextualize the query. The method 400 can use a system operatively coupled to the processor (e.g., artificial intelligence component 210) to use keyword extraction to contextualize the query.

At 410, method 400 includes using named entity recognition to contextualize the query. The method 400 can use a system operatively coupled to the processor (e.g., artificial intelligence component 210) to use named entity recognition to contextualize the query.

At 412, method 400 includes determining sufficiency of the query. The method 400 can use a system operatively coupled to the processor (e.g., artificial intelligence component 210) to determine sufficiency of the query.

At 414, the method 400 includes determining that the query does not contain sufficient information and issuing a request for more information. The method 400 can use a system operatively coupled to the processor (e.g., artificial intelligence component 210) to determine that the query does not contain sufficient information and issue a request for more information.

At 416, method 400 includes providing customized recommendations to modify the natural language query. The method 400 can use a system operatively coupled to the processor (e.g., artificial intelligence component 210) to provide a potential recommendation to modify the query.

At 418, method 400 includes receiving a modified query. The method 400 can use a system operatively coupled to the processor (e.g., natural language processing component 206) to receive a modified query.

At 420, the method 400 includes interpreting the modified query. The method 400 can use a system operatively coupled to the processor (e.g., natural language processing component 206) to interpret the modified query.

At 422, the method 400 includes contextualizing the modified query. The method 400 can use a system operatively coupled to the processor (e.g., artificial intelligence component 210) to contextualize the modified query.

At 424, method 400 includes inferring a potential result of the contextualized query.

At 426, method 400 includes searching metadata of the potential query result. The method 400 can use a system operatively coupled to the processor (e.g., artificial intelligence component 210, search component 212) to search metadata of the potential query result.

At 428, method 400 includes executing the contextualized query. The method 400 can use a system operatively coupled to the processor (e.g., search component 212) to execute the contextualized query.

One or more systems, devices, computer program products, and/or computer-implemented methods provided herein relate to contextualization of version control requests. A system can include a processor that executes computer executable components stored in memory. The computer executable components can include a tracking component that tracks content changes. The computer executable components can further include a natural language processing component that interprets a natural language query. The computer executable components can further include an artificial intelligence component that contextualizes, based at least in part on the tracked content changes, the query and infers sufficiency of a potential result of the contextualized query.

Advantages of this system can include streamlined content selection and retrieval, enhanced search efficiency, and increased productivity.

In some embodiments of the aforementioned system, the tracking component tracks content changes. The tracking component can monitor and detect changes made to content, such as additions, deletions, or updates. When changes are detected, the tracking component can capture relevant metadata, such as timing of modification, type of modification, and/or an identity of a user or system that initiated the change. The tracking component can incorporate version control functionality, maintaining a history of content modifications and allowing users or systems to revert to previous versions.

According to some embodiments, the natural language processing component interprets a natural language query. The natural language processing component 106 can utilize word embedding to interpret the query. This can allow for an unstructured query to be preprocessed with identified key information.

The artificial intelligence component can contextualize, based at least in part on the tracked content changes, the query and infers sufficiency of a potential result of the contextualized query. The artificial intelligence component can determine sufficiency of the query as a function of a confidence score of utility to a user of the query. The artificial intelligence component can further use situational analysis to determine sufficiency of the query. According to an embodiment, upon determining that the query will not result in utility, the artificial intelligence component can request more information. In other embodiments, the artificial intelligence component can provide customized recommendations to modify the natural language query. The customized recommendations can be based at least in part upon the tracked content changes. In various embodiments, the artificial intelligence component can use named entity recognition to contextualize the query. The artificial intelligence component can analyze metadata of the potential query result. The artificial intelligence component can use keyword extraction to contextualize the query.

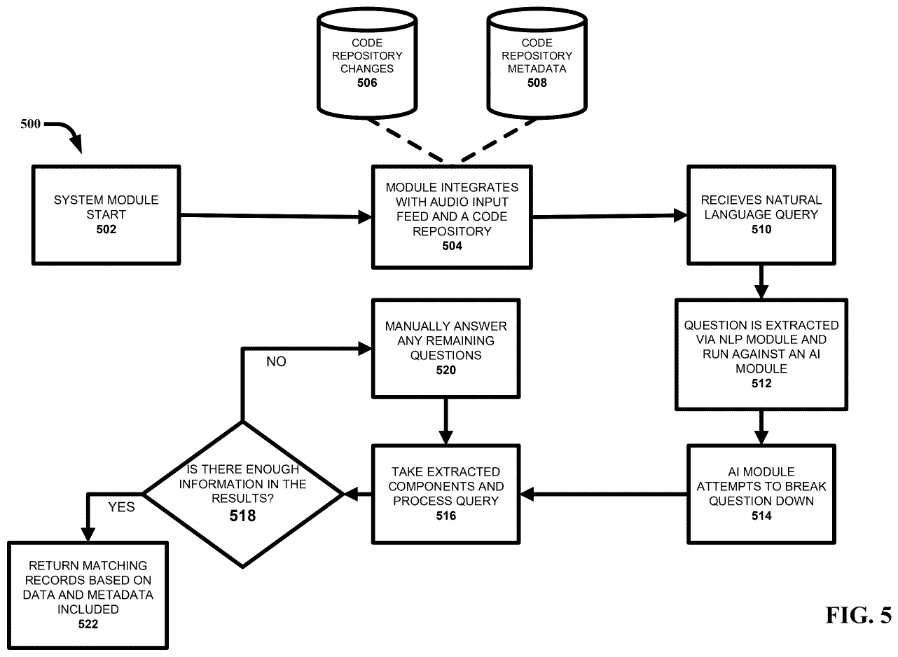

FIG. 5 illustrates an example flow diagram that can facilitate contextualization of a natural language query in accordance with some of the embodiments described herein. At 502, the system module starts. The system module integrates 504 with an audio input feed and a code repository. The repository can comprise code repository changes 506 (e.g., content changes) and code repository metadata 508. The changes can be categorized by tagging mechanisms to improve tracking and identification within the repository. The system module receives a natural language query 510. Natural language query 510 can be received verbally. At 512, the natural language question is extracted via an NLP module and runs against an AI module. The natural language query can be initially preprocessed to remove any irrelevant information, noise, or inconsistencies. This can include tokenization, lowercasing, and removal of stop words and punctuation marks. The preprocessed text can be converted into numerical format using word embeddings, or by using the embedding layer provided by the artificial intelligence model. These embeddings can help to represent the words in a multi-dimensional space, capturing their semantic meaning and relationships. The embedded query can be passed as input to the artificial intelligence model, which can be pre-trained on a large dataset of version control data, including code changes, metadata, comments, and commit messages. The model can be fine-tuned to understand and interpret the context of user queries in version control systems. The artificial intelligence model can process the input and generate an output that contains the relevant information needed to understand the context of the query and identify relevant content.

At 514, the AI module attempts to break down the query (e.g. the question) and identify a “who,” “what,” “when,” “where,” and “how” of the query. A Named Entity Recognition (“NER”) layer can be applied to the output generated by the AI model. NER can be used to identify and categorize entities mentioned in text (e.g., people, organizations, dates, and locations). Using additional NLP techniques, such as keyword extraction, topic modelling, and sentiment analysis, the “what,” “why,” and “how” components of the query can be further extracted. Keyword extraction can be used to identify main topics. Sentiment analysis can be used to provide insight into the purpose of a query. Topic modelling can be used to better understand the overall context of a query.

The information extracted from the NER and other NLP techniques can be merged to form a structured representation of the query, which can include the “who,” “what,” “when,” “where,” and “how” components of the query. The system can take extracted components and process 516 the query. This structured representation of the query can be used when searching the version control system. In some embodiments, the version control system can be searched for code changes. In other embodiments, the version control system can be searched for metadata, such as comments and commit messages. The structured representation of the query can further be used to retrieve the most relevant content.

At 518, the system can determine if there is enough information in the results to identify the correct content. If the system determines at 518 that there is not enough information to identify the correct content, the system proceeds to 520, wherein the system outputs a request for any remaining questions to be answered manually. If the system determines at 518 that there is enough information to identify the correct content, the system proceeds to 522, wherein the system returns an answer based on matched content (e.g. matched data and/or metadata).

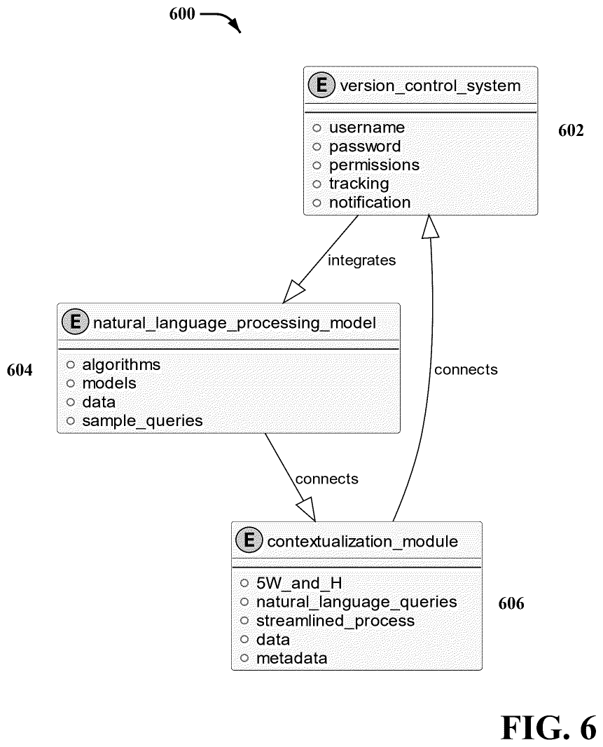

FIG. 6 illustrates an example entity relationship diagram in accordance with some embodiments described herein. Entities can include a version control system 602, a natural language processing model 604, and a contextualization module 606. The version control system 602 can track content changes and record associated user data information to tailor content visibility. The natural language processing model 604 can quantify the requested natural language query and can store algorithms, models, data, and sample queries. The contextualization module 606 can provide further context and understanding to the preprocessed query. Entity 606 can store the “who,” “what,” “where,” and “how” of a query, previous natural language queries, data, and metadata. Additionally, the contextualization module 606 can store streamlined processes in case the system is provided with a specific query. The version control system 602 can integrate with the natural language processing model 604 to be processed or analyzed using techniques or systems stored in 604. The natural language processing model 604 can connect with the contextualization module 606 to further process the query. The contextualization module 606 can connect with the version request system 602 to provide relevant information or context, which can be associated with content located within 602 without directly altering its content.

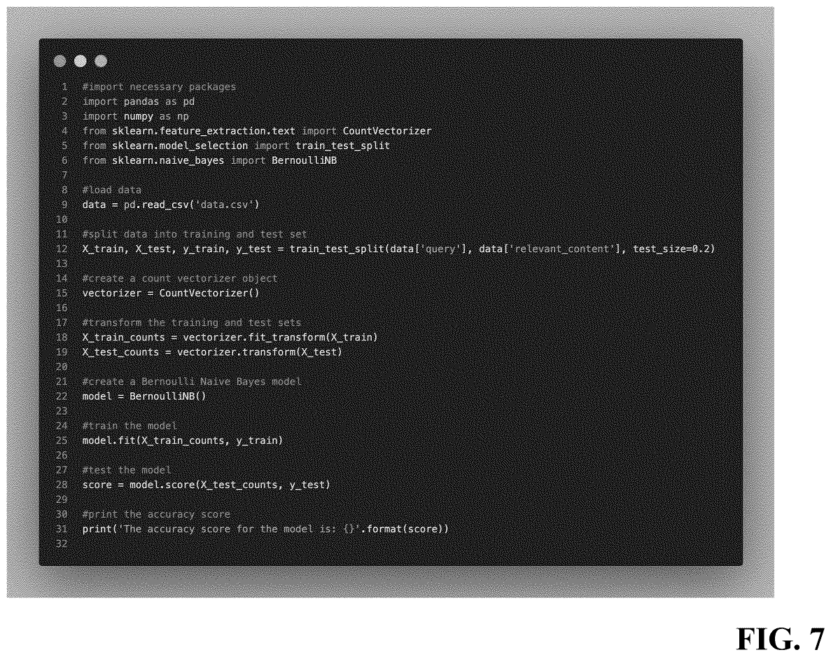

FIG. 7 illustrates an example code for training a natural language processing model in accordance with some of the embodiments described herein. The code can define a structure and sequence of operations that can be used to import necessary packages, process input data, train a model, and test the model. The figure illustrates an example of how input data can be processed by dividing the data into training or test sets. A count vectorization can be applied to convert text data into numerical form. The sets can be transformed for model training and evaluation. The Bernoulli Naïve Bayes model can be used to train the model with training data.

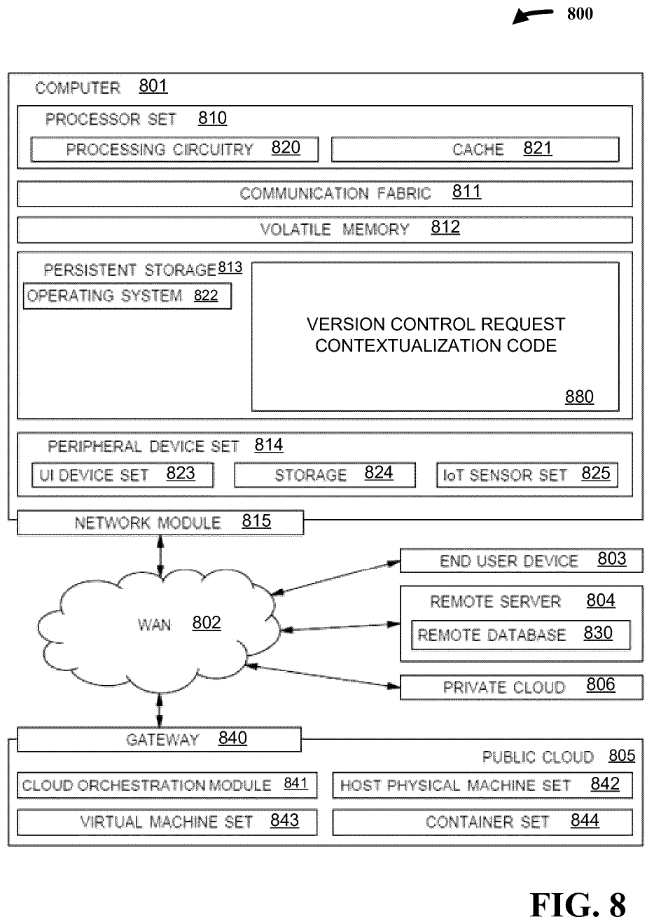

FIG. 8 and the following discussion are intended to provide a brief, general description of a suitable computing environment 800 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as contextualizing, based at least in part on tracked content changes, a query version control request with contextualization code 880. In addition to block 880, computing environment 800 includes, for example, computer 801, wide area network (WAN) 802, end user device (EUD) 803, remote server 804, public cloud 805, and private cloud 806. In this embodiment, computer 801 includes processor set 814 (including processing circuitry 820 and cache 821), communication fabric 811, volatile memory 812, persistent storage 813 (including operating system 822 and block 845, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method can be distributed among multiple computers and/or between multiple locations. On the other hand, in this presentation of computing environment 800, detailed discussion is focused on a single computer, specifically computer 801, to keep the presentation as simple as possible. Computer 801 can be located in a cloud, even though it is not shown in a cloud in FIG. 8. On the other hand, computer 801 is not required to be in a cloud except to any extent as can be affirmatively indicated.

PROCESSOR SET 810 includes one, or more, computer processors of any type now known or to be developed in the future. Processing circuitry 820 can be distributed over multiple packages, for example, multiple, coordinated integrated circuit chips. Processing circuitry 820 can implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set can be located “off chip.” In some computing environments, processor set 810 can be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods can be stored in block 845 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory can be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 can be a read only memory (ROM), but typically at least a portion of the persistent storage allows writing of data, deletion of data and re-writing of data. Some familiar forms of persistent storage include magnetic disks and solid-state storage devices. Operating system 822 can take several forms, such as various known proprietary operating systems or open-source Portable Operating System Interface type operating systems that employ a kernel. The code included in block 845 typically includes at least some of the computer code involved in performing the inventive methods.

PERIPHERAL DEVICE SET 814 includes the set of peripheral devices of computer 801. Data communication connections between the peripheral devices and the other components of computer 801 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 can include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 can be persistent and/or volatile. In some embodiments, storage 824 can take the form of a quantum computing storage device for storing data in the form of qubits. In embodiments where computer 801 is required to have a large amount of storage (for example, where computer 801 locally stores and manages a large database) then this storage can be provided by peripheral storage devices designed for storing large amounts of data, such as a storage area network (SAN) that is shared by multiple, geographically distributed computers. IoT sensor set 825 is made up of sensors that can be used in Internet of Things applications. For example, one sensor can be a thermometer, and another sensor can be a motion detector.

NETWORK MODULE 815 is the collection of computer software, hardware, and firmware that allows computer 801 to communicate with other computers through WAN 802. Network module 815 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801) and can take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 can be a client device, such as thin client, heavy client, mainframe computer and/or desktop computer.

REMOTE SERVER 804 is any computer system that serves at least some data and/or functionality to computer 801. Remote server 804 can be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data can be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs can be stored as images and can be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware and firmware allowing public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods, and/or computer program products according to some embodiments described herein. In this regard, each block in the flowchart or block diagrams can represent a module, segment, and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components, and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches, and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

1. A system, comprising:
a processor that executes computer executable components stored in memory, wherein the computer executable components comprise:
a tracking component that tracks content changes, wherein the tracking component monitors and detects changes made to content, including additions, deletions, or updates;
a natural language processing component that interprets a natural language query, wherein the natural language processing component preprocesses the natural language query with identified key information;
an artificial intelligence component that contextualizes, based at least in part on the tracked content changes, the query and infers sufficiency of a potential result of the contextualized query, wherein the artificial intelligence component determines whether there is enough information in results associated with the contextualized query to identify correct content; and
a search component that searches metadata of the potential query result and executes the contextualized query.

2. The system of claim 1, wherein the search component executes the contextualized query to return matching records based on included data and metadata.

3. The system of claim 1, wherein the artificial intelligence component determines sufficiency of the query as a function of a confidence score of utility to a user of the query, including determining whether there is enough information to identify correct content.

4. The system of claim 3, wherein the artificial intelligence component uses situational analysis to determine sufficiency of the query based on utility of the query.

5. The system of claim 4, wherein, upon determining that the query will not result in utility, the artificial intelligence component requests more information to identify the correct content.

6. The system of claim 1, wherein the artificial intelligence component provides customized recommendations to modify the natural language query and receives a modified query.

7. The system of claim 6, wherein the customized recommendations are based at least in part upon the tracked content changes, including code repository changes.

8. The system of claim 1, wherein the natural language processing component utilizes word embedding to interpret the query, wherein the query is converted into numerical format using the word embedding.

9. The system of claim 1, wherein the artificial intelligence component uses named entity recognition to contextualize the query by identifying and categorizing entities mentioned in text.

10. The system of claim 1, wherein the artificial intelligence component analyzes metadata of the potential query result, wherein the metadata comprises comments or commit messages.

11. The system of claim 1, wherein the artificial intelligence component uses keyword extraction to contextualize the query, wherein the keyword extraction identifies main topics associated with the query.

12. A computer-implemented method that utilizes a processor that executes computer executable components stored in memory to perform the following acts:
tracking content changes, including monitoring and detecting additions, deletions, or updates associated with content;
interpreting a natural language query, including preprocessing the natural language query with identified key information;
contextualizing, based at least in part on the tracked content changes, the query;
inferring a potential result of the contextualized query, including determining whether there is enough information to identify correct content;
searching metadata of the potential query result; and
executing the contextualized query.

13. The method of claim 12, wherein the executing the contextualized query further comprises returning matching records based on included data and metadata.

14. The method of claim 12, further comprising determining sufficiency of the query as a function of a confidence score of utility to a user of the query.

15. The method of claim 14, further comprising using situational analysis to determine sufficiency of the query to determine whether there is enough information to identify correct content.

16. The method of claim 12, further comprising determining that the query does not contain sufficient information, and issuing a request for more information to identify the correct content.

17. The method of claim 12, wherein the metadata of the potential query result further comprises comments or commit messages.

18. The method of claim 12, wherein the customized recommendations are based at least in part upon the tracked content changes, including code repository changes.

19. The method of claim 12, further comprising using keyword extraction to contextualize the query, wherein the keyword extraction identifies main topics associated with the query.

20. A computer program product comprising a computer readable storage medium having program instructions embodied therewith, the program instructions executable by a processor to cause the processor to:
track content changes, including monitoring and detecting additions, deletions, or updates associated with content;
receive a natural language query;
interpret the query, including preprocessing the natural language query with identified key information;
contextualize, based at least in part on the tracked content changes, the query;
infer a potential result of the contextualized query, including determining whether there is enough information to identify correct content;
search metadata of the potential query result; and
execute the contextualized query.
